(19) United States
(12) Patent Application Publication
(10) Pub. No.: US 2005/0046595 A1
(43) Pub. Date: Mar. 3, 2005

(54) SOLAR POWERED SIGN ANNUNCIATOR

(75) Inventor: John Randolph Blyth, Tallahassee, FL (US)

Correspondence Address: John;Blyth, 3525 Colonnade Dr., Tallahassee, FL, 32309, US

(73) Assignee: Mr.John Randolph Blyth, Tallahassee, FL (US)

(21) Appl. No.: 10/604,917

(22) Filed: Aug. 26, 2003

(51) Int. Cl. G08G 1/095

(52) U.S. Cl. 340/908; 340/815.45

(57) ABSTRACT

A solar powered sign annunciator comprised of a plurality of high intensity light emitting diodes (LED); a microprocessor controller to regulate power consumption and annunciator characteristics, battery charging and sensor response with an integrated software charge controller; a minimalized solar panel array sized to produce sufficient power for battery charging under normalized solar radiation to latitudes as far north as 45 degrees; a direction sensing Doppler radar to determine the approach of traffic; a low voltage battery to minimize power control losses to the LED array; a temperature sensor to determine proper charging battery status and battery capacity; and a plurality of analog to digital (A/D) converters incorporated in the microprocessor to sense solar power output, temperature input, battery voltage and charging current and Doppler phase shift differential. The system also includes a housing arrangement to incorporate all aforementioned items in a weathertight enclosure providing sufficient horizontal surface for solar cell attachment yet in a package compact enough to easily attach to existing designed signs.

### BACKGROUND OF INVENTION

Signs of all types are ubiquitous but in general we are asked to pay particular attention to signs that convey safety information. Many signs of this type are displayed virtually everywhere the general public travels. For example, lighted emergency exit signs shows us the way to an exit during fires while stop signs, way one signs, yield signs and many others guide us, caution us and inform us while driving. Everyone knows, for example, that a stop sign means to bring your vehicle to a stop and look for other traffic before proceeding. However, because of their common nature and ever-present appearance combined with other ordinary distractions that draw a driver's attention away from constant diligence, important safety signs are often missed, sometimes leading to catastrophic consequences. In recognition of this and in an attempt to draw a drivers attention to particularly important ones, attempts have been made to emphasis the more critical ones through means such as road bumps causing the car to vibrate as a sign is approached or by constantly blinking warning lights. Unfortunately most of these attempts at notification are either expensive to install and difficult to maintain or require a connection to a power source for the energy necessary to power a constantly flashing light. Powered solutions also are expensive with the cost of electricity always a present factor.

Attempts have been made to address this situation. By way of example, U.S. Pat. No. 6,198,410 to White et. al. discloses a lighting system that provides additional lighting to a traffic sign at night when the vehicle headlights fail to provide sufficient illumination. U.S. Pat. No. 6,422,714 B1 to Hubbell also discloses a very similar situation that also provides nighttime illumination to a traffic sign. While these devices do provide additional illumination at night and therefore meet the objectives and requirements of the aforementioned patents, they incorporate electroluminescent panels or incandescent lights to provide night time illumination to the sign fascia. Neither approach provides any appreciable forward direction light output capable of high visibility and hence fail to provide the attention capturing aspect associated with a bright, flashing light directed towards the driver and not the sign fascia and in particular neither provides any notification of sign approach during daylight hours.

Further U.S. Pat. No. 6,407,675 B1 to Mumford et. al. while disclosing a light utilizing a flashing light including an LED fails to address the need for high visibility by incorporating high intensity LEDs along with a plurality of LEDs necessary to attract attention and fails to provide for adequate power control to be able to operate a energy consuming device not connected to the electric power grid through the use of a simple on/off switch. Likewise U.S. Pat. No. 6,239,691 B1 to Preisler discloses another flashing light with the same drawbacks as Mumford. Further still, the need exists that when providing a visual highlight more than a small single flashing light is required to capture a drivers attention at a distance from the sign where the driver can take effective action. An few lights on the periphery is inadequate and in most cases will cause added confusion particularly at night when the sign itself is not well lighted and a few periphery lights from a distance may make the appearance of the sign to be something other than what it is. For example, eight lights, one on each corner of the octagon of a stop sign, will appear at night from a distance to be a circular information sign, not a stop sign since the lights will form a circle that only become apparent as an octagon at a much closer view.

There is, therefore, a need to provide a system that will directly, immediately and unequivocally capture a drives attention through the use of day and night time highly visible bright flashing lights as a vehicle approaches a safety sign. The bright lights prime purpose is to capture a drivers attention by aiming the light output at the approaching vehicle and only incidentally produce minor secondary illumination to the sign fascia. The present invention provides a traffic sign that upon detection of a vehicle flashes bright lights while maintaining the look and appearance of the traffic sign when not providing annunciation.

### SUMMARY OF INVENTION

It is an object of the present invention to provide a fully self-contained traffic sign with a day and night time annunciator lighting system that meet the design codes set forth in the Manual of Uniform Traffic Control Devices and other standards while avoiding the disadvantages of prior art.

It is another object of the present invention to produce a sign whose outward appearance retains the same familiar shape and look while providing visual enhancement upon vehicle approach 24 hours per day regardless of ambient lighting conditions.

It is still another object of the present invention to provide visual enhancement to the sign in such a manner that the major sign objectives as provided by the signage lettering, numbering or symbols are enhanced directly providing unequivocal direction to the driver.

It is still another object of the present invention to provide signage that can be field retrofit on existing sign posts and not require the use specialized installation techniques nor connections to the electric power grid.

It is further an object of the present invention to provide a new and improved annunciator traffic safety sign that is inexpensive to manufacture and easy to maintain and therefore cost effective to purchase to upgrade highway signage.

It is further still an object of the present invention to incorporate microprocessor control for all functions thereby allowing minimal solar cell requirements through the use of tightly controlled power usage and maximized charging with available sunlight up to latitudes of 45 degrees north and south.

It is another object of the present invention to use Doppler radar to detect the approach of the vehicle and to allow the device to conserve energy while no vehicles are present.

In summary, the present invention provides a traffic sign that upon the approach of a vehicle flashes bright lights to capture the driver's attention while still meeting the requirements of the Manual of Uniform Traffic Control Devices. The sign is activated by radar detection of the vehicle and is powered by a self-contained battery operated and solar cell recharged power system that is monitored and controlled via microprocessor.

This and other objects of the present invention as well as a better understanding of the advantages will become more apparent from reading the following detailed descriptions and the accompanying drawings.

### BRIEF DESCRIPTION OF DRAWINGS

FIG. 1 is a system block diagram of the electrical schematic showing the electrical elements.

FIG. 2 is a side view of the present invention showing the face of the sign and annunciator locations along with the housing attached to the back containing the electronics, battery and solar panel.

FIG. 3 is layout of the circuit boards depicting the placement of LEDs used to form the letter “Y” such as in the word Yield.

FIG. 4 shows an exploded view of a stop sign with the LED panel array, housing and solar panel placement.

### DETAILED DESCRIPTION

The present invention will be described using a one way sign as illustrative purposes only. To those knowledgeable in the art, other configurations are possible by arranging the various parts to provide annunciation to any other type traffic safety sign.

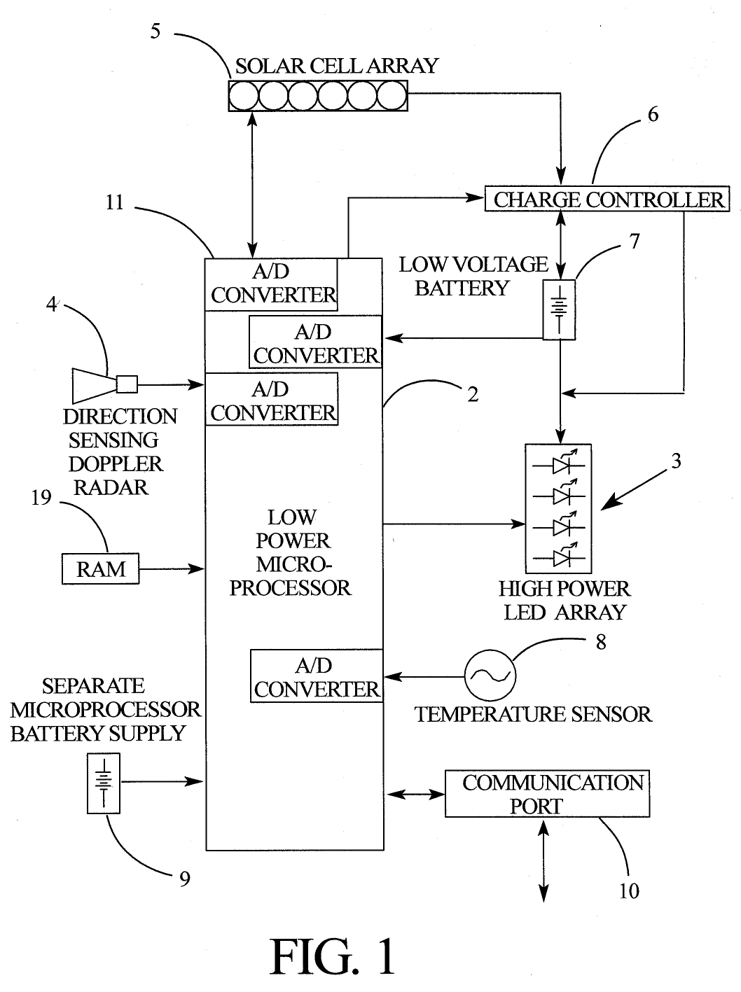

The elements of the present invention are illustrated in FIG. 1. The microprocessor controller 2 is an industry standard integrated circuit that is supplied in many different configurations consisting of varying plurality of input/output control lines, program and internal memory configurations and various other hardware options. It is not the intent of the present invention to specify the exact microprocessor configuration other to include a generic microprocessor as an integral feature of the invention necessary for the control of the subsystems. The microprocessor 2 contains a set of software routines burned into program memory that control and direct the internal operation of the microprocessor. The external random access memory (RAM) memory 19 is attached through one of several commonly utilized industry standard possible hardware configurations depending on the type processor selected whose purpose is to provide additional memory beyond what may be provided internally in the microprocessor 2 and to store and record events such as but not limited to number of vehicles passes, battery charging state, solar cell charging capacity, and external communication events.

The Doppler radar 4 is used to detect the on-coming vehicles and to provide adequate sensing range as to enable the sign to begin flashing while the vehicle is still far enough away for the driver to take action. The Doppler radar 4 is the only device that will protrude from the front edge of the sign fascia.

The solar cell array 5 is s single liner array of single or multi-crystalline solar cells connected in series to produce sufficient voltage and current to be able to recharge the enclosed battery 7 under normalized averaged solar radiation up to 45 degrees north and south latitude. The panel is configured to mount on top of the electronics housing behind the sign fascia.

The charge controller 6 is an integrated circuit performing several functions. It incorporates several current sensors. One sensor determines the current flow rate from the solar cell array 5 while another monitors the current flow rate to the battery 7 to determine charging status. Another sensor measures the current usage rate from the battery 7 to the LED array 3. The charge controller 6 incorporates a step-up DC-DC converter to properly balance the charging voltage to the battery 7 from the voltage and current level available from the solar cell array 5 depending on the incident solar radiation at any given time.

The battery is a low voltage lead acid type with a nominal voltage of 4 volts. This allows direct connection to the LED array 3 without energy wasting step down voltage regulators and can be charged with a minimal voltage generated from the solar cell array 5.

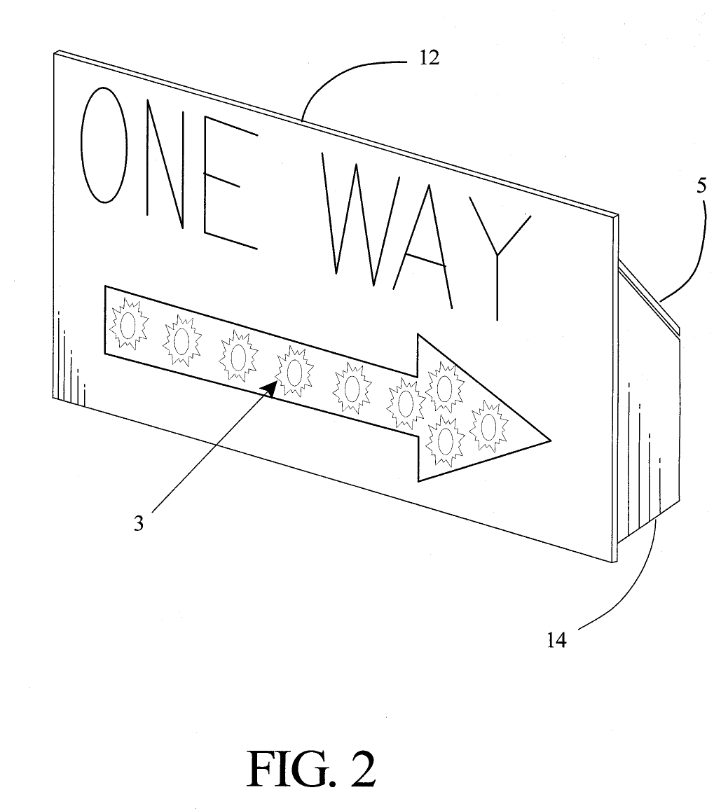

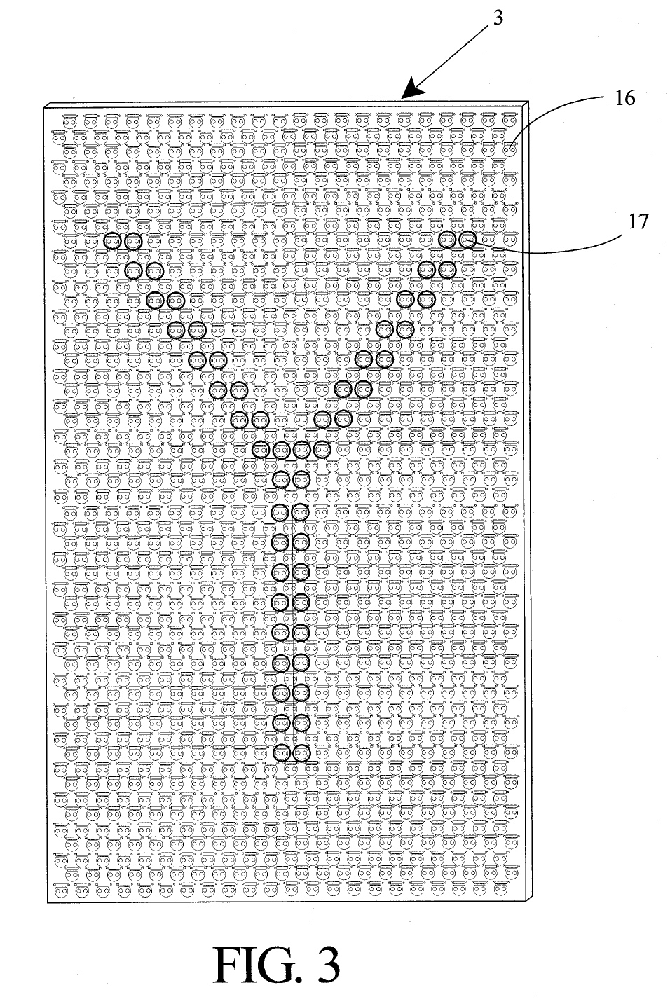

The high power LED array 3 consists of a plurality of light emitting diodes (LED). The LEDs are a high candle power device with a minimum millicandle power of at least 5,000 and a viewing angle of at least 30 degrees thereby allowing the approaching vehicle to easily view the annunciation even during daylight and also allowing the vehicle to be off center from the sign and still be within the viewing angle. The LEDs are arranged in a pattern consistent with the lettering or other such symbol indicated on the sign that is designated to be highlighted. Referring to FIG. 3, a circuit board is designed in a systematic pattern with a plurality of LED mounting holes 16 allowing virtually any pattern to be soldered in place. This figure shows the letter “Y” 17 such as might be encountered in a YIELD sign. Further, any number of LED arrays can be arranged behind the sign to accommodate any letter or symbol to be highlighted. Referring to FIG. 2, holes are drilled through the sign fascia to allow the LED pattern to protrude through the sign thereby allowing the LEDs to be visible from the front of the sign. In this example, the arrow on a one way sign is highlighted.

Referring to FIG. 1, a temperature sensor 8 is attached to the microprocessor 2 to allow the microprocessor 2 to determine the ambient temperature and hence the level of energy available from the battery 7 to power the LED array 3. The number of times the LEDs can be flashed is determined by the energy level available from the battery 7 as calculated by the microprocessor 2.

The microprocessor 2 is supplied with an external battery source 9 to allow the microprocessor 2 to operate regardless of the state of charge of the primary battery source 7 so as to be able to direct the overall operation of the system. This battery 9 is also recharged from the solar cell array 5 and is sized to allow extended operation of the microprocessor 2 which makes a determination if sufficient solar energy has been received and stored by the primary battery 7 for continued operation of the LED array.

The communication port 10 is a peripheral input/output port of the microprocessor 2 allowing an external device to query the status of the internal operation and stored values of the system. The communication port is an RS-232, RS-485, wireless, fiber optic, USB or any other industry standard used for common communication to microprocessors.

The microprocessor 2 is equipped with a plurality of analog to digital converters (A/D) 11 thereby allowing the microprocessor 2 to obtain information from outside analog devices such as the Doppler radar 4, solar cell 5 status, battery 7 status, and ambient temperature 8. The solar cell array 5 also provides an indication of the ambient outside light conditions thereby allowing the microprocessor 2 to adjust the duty cycle of the LEDs 3 and therefore controlling the brightness of the light output to be adjusted to a lower level during low light conditions experienced at night or during extreme overcast weather conditions. Since the LED is a highly directional device with virtually all light output directed forward, reduction of light intensity is important during low ambient light conditions to prevent temporary blindness to the driver during the flashing.

Referring to FIG. 2, the representative one way sign 12 is modified through the use of a plurality of holes drilled or punched through the sign to allow the LED pattern array 3 to protrude through the front of the sign so as to be advantageously viewed by an approaching vehicle. While the present invention has been shown as having a particular annunciation pattern, a person skilled in the art will understand that other annunciation patterns are applicable to any sign and in doing so doesn't change the object and intent behind this invention. Mounted behind the sign and concealed by the sign so as not to change the front appearance is the housing 14 that provides protection to the enclosed electronics and forms the support structure for the solar cell array 5. Further, the housing 14 is predrilled with the standard mounting holes applicable to the particular sign type allowing the sign to be mounted on existing poles or structures without further modification. The solar cell array 5 is advantageously disposed to gather the maximum available solar energy.

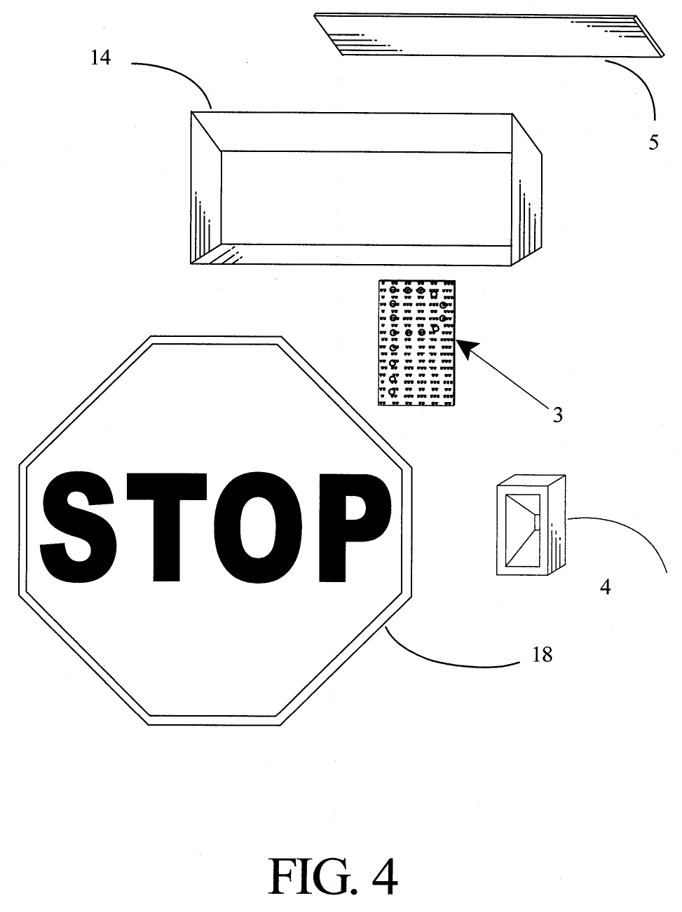

Referring to FIG. 4 an exploded view of a representative STOP sign shows the assembly configuration of a typical annunciated sign. The LED array 3, shown in this drawing configured for the letter “P” is attached behind the letter “P” in the word STOP is protected inside the housing 14 attached to the rear of the sign. The housing 14 also forms the attachment surface the solar cell array 5. All other electronics including the battery 7 is also contained in the housing to protect from weather and other damage. Also shown is the Doppler radar 4 advantageously disposed to the front of the sign for maximum detection range of the oncoming vehicles.

1. An enhanced sign comprising:
a) a sign panel modified to allow a plurality of high intensity LEDs to protrude through the sign fascia so as to be visible from the front;
b) a microprocessor controller to direct all sign functions to control power usage, LED flash rate and timing, and battery charging;
c) a plurality of forward facing high intensity light emitting diodes arranged in a pattern to represent letters or numbers or other sign indicia, the LEDs mounted to a printed circuit board, the printed circuit board with a prearranged standard pattern allowing the creation of any combination of letters, numbers or symbols;
d) a housing disposed behind the rear of the sign fascia containing all electronics, batteries and circuit board, the top which forms the support for the solar panel array, the housing which is predrilled for sign mounting;
e) a solar cell panel consisting of a plurality of cells connected in series, the panel electrically connected and controlled by the charge controller;
f) a long range radar detector disposed within the housing and connected to the microprocessor for control;
g) a low voltage battery sized to produce enough energy to power the LED array a predetermined number of times, to be recharged with the available solar energy available through said solar panel;
h) a temperature sensor to determine ambient temperature;
i) a microprocessor battery supply to operate said microprocessor independently of the low voltage battery;
j) an integrated random access memory (RAM) to allow additional storage of operational data for later retrieval.
k) an integrated communication port allowing for external communication to the microprocessor for data retrieval and upload of modification to operating parameters.

2. An enhanced sign as in claim 1, wherein said sign is a traffic safety sign.
